(19) United States
(12) Patent Application Publication
(10) Pub. No.: US 2025/0192828 A1
(43) Pub. Date: Jun. 12, 2025

(54) METHOD AND APPARATUS FOR BEAM CONFIGURATION OF RECONFIGURABLE INTELLIGENT SURFACE IN COMMUNICATION SYSTEM

(71) Applicant: Electronics and Telecommunications Research Institute, Daejeon (KR)

(72) Inventors: Seon Ae KIM, Daejeon (KR); Hee Sang CHUNG, Daejeon (KR)

(21) Appl. No.: 18/979,391

(22) Filed: Dec. 12, 2024

(30) Foreign Application Priority Data
Dec. 12, 2023 (KR) 10-2023-0180059

(51) Int. Cl. H04B 7/04; H04B 7/06

(52) U.S. Cl. CPC H04B 7/04013; H04B 7/06952

(57) ABSTRACT

The present disclosure relates to a beam configuration technique for a reconfigurable intelligent surface. A method of a base station may comprise: generating first installation information of the base station including information on at least one transmission beam; requesting second installation information of an RIS from an RIS controller, the RIS being located nearby the base station; receiving, from the RIS controller, the second installation information including information on at least one reflection beam of the RIS; and determining at least one shadowed area covered by the at least one transmission beam and the at least one reflection beam based on the first installation information and the second installation information.

### CROSS-REFERENCE TO RELATED APPLICATIONS

This application claims priority to Korean Patent Application No. 10-2023-0180059, filed on Dec. 12, 2023, with the Korean Intellectual Property Office (KIPO), the entire contents of which are hereby incorporated by reference.

### BACKGROUND

### 1. Technical Field

The present disclosure relates to a technique for configuring beams of a reconfigurable intelligent surface in a communication system, and more particularly, to a technique for configuring beams of a reconfigurable intelligent surface in a communication system, which enables configuration of beams of the reconfigurable intelligent surface by using a codebook configured with a set of specific phase shift values.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Meanwhile, millimeter-wave (mmWave) communication may be one of the core technologies of 5G communication systems. Such millimeter waves may experience severe path loss and blockage of line of sight between communication devices. A reconfigurable intelligent surface (RIS) may be a technology to improve the performance of such millimeter-wave wireless communication. The RIS can be operated by configuring its beams using a codebook composed of a set of specific phase shift values designed to have several candidate beams, thereby reducing system complexity.

### SUMMARY

The present disclosure for resolving the above-described problems is directed to providing a method and an apparatus for configuring beams of a reconfigurable intelligent surface in a communication system, which enable configuration of beams of the reconfigurable intelligent surface by using a codebook configured with a set of specific phase shift values.

A method for configuring beams of a reconfigurable intelligent surface (RIS) in a communication system, performed by a base station according to a first exemplary embodiment of the present disclosure, may comprise: generating first installation information of the base station including information on at least one transmission beam; requesting second installation information of a reconfigurable intelligent surface (RIS) from an RIS controller, the RIS being located nearby the base station; receiving, from the RIS controller, the second installation information including information on at least one reflection beam of the RIS; and determining at least one shadowed area covered by the at least one transmission beam and the at least one reflection beam based on the first installation information and the second installation information.

The information on the at least one transmission beam may include at least one of: information on a number of the at least one transmission beam, information on a beam width of each of the at least one transmission beam, or information on a beam direction of each of the at least one transmission beam.

The information on the at least one reflection beam may include at least one of: information on a number of reflection beams for the at least one transmission beam, information on a beam width of each of the reflection beams for the at least one transmission beam, or information on a beam direction of each of the reflection beams for the at least one transmission beam.

The first installation information may include one of information on an installation location of the base station or information on a number of the at least one transmission beam of the base station.

The second installation information may include at least one of: information on an installation location of the RIS, information on a number of reflection elements of the RIS, or information on an azimuth of the RIS.

The method may further comprise: generating a mapping table by mapping an identifier (ID) of the RIS, information on one transmission beam from the at least one transmission beam, information on one reflection beam from the at least one reflection beam, and information on one shadowed area from the at least one shadowed area.

The method may further comprise: providing a service to a terminal; estimating a location of the terminal; identifying an interruption of the service for the terminal; identifying that the terminal exists in one shadowed area among the at least one shadowed area; selecting one transmission beam of the at least one transmission beam and one reflection beam of the at least one reflection beam, which cover the one shadowed area; and transmitting a signal to the terminal via the RIS based on the selected one transmission beam and the selected one reflection beam.

The transmitting of the signal to the terminal via the RIS based on the selected one transmission beam and the selected one reflection beam may comprise: identifying a codebook based on the selected one transmission beam and the selected one reflection beam; transmitting the identified codebook to the RIS controller; and transmitting the signal to the RIS using the selected one transmission beam.

The selecting of the one transmission beam of the at least one transmission beam and the one reflection beam of the at least one reflection beam, which cover the one shadowed area, may comprise: transmitting, to the RIS controller, 1-bit discrete phase shift codebooks related to the selected one transmission beam; transmitting, to the RIS, first reference signals related to the 1-bit discrete phase shift codebooks; receiving, from the terminal, information on first received signal qualities for the first reference signals; identifying one first reference signal of the first reference signals, which has a best received signal quality, based on the first received signal qualities; identifying one 1-bit discrete phase shift codebook corresponding to the identified one first reference signal; and selecting a reflection beam related to the identified one 1-bit discrete phase codebook as the selected one reflection beam.

The selecting of the reflection beam related to the identified one 1-bit discrete phase codebook as the selected one reflection beam may comprise: transmitting, to the RIS controller, 2-bit discrete phase codebooks subordinate to the identified one 1-bit discrete phase shift codebook; transmitting, to the RIS, second reference signals related to the 2-bit discrete phase shift codebooks; receiving, from the terminal, information on second received signal qualities for the second reference signals; identifying one second reference signal of the second reference signals, which has a best received signal quality, based on the second received signal qualities; identifying one 2-bit discrete phase shift codebook corresponding to the one second reference signal; and selecting a reflection beam formed by the identified one 2-bit discrete phase codebook as the selected one reflection beam, wherein a reflection area of the reflection beam formed by the identified one 2-bit discrete phase codebook is included in a reflection area of the selected one reflection beam formed by the identified one 1-bit discrete phase codebook.

A method for configuring beams of a reconfigurable intelligent surface (RIS) in a communication system, performed by an RIS controller according to a second exemplary embodiment of the present disclosure, may comprise: receiving, from a base station, a request for first installation information of an RIS; transmitting, to the base station, the first installation information including information on at least one reflection beam of the RIS; receiving, from the base station, a codebook related to at least one transmission beam and at least one reflection beam determined based on the first installation information and second installation information of the base station; and transmitting, to the RIS, the codebook received from the base station.

The first installation information may include one of information on an installation location of the RIS or information on a number of reflection elements of the RIS.

The second installation information may include one of information on an installation location of the base station or information on a number of the at least one transmission beam of the base station.

The codebook may be a 1-bit discrete phase shift codebook or a 2-bit discrete phase codebook.

An apparatus for configuring beams of a reconfigurable intelligent surface (RIS) in a communication system, which is a base station according to a third exemplary embodiment of the present disclosure, may comprise at least one processor, and the at least one processor may cause the base station to perform: generating first installation information of the base station including information on at least one transmission beam; requesting second installation information of a reconfigurable intelligent surface (RIS) from an RIS controller, the RIS being located nearby the base station; receiving, from the RIS controller, the second installation information including information on at least one reflection beam of the RIS; and determining at least one shadowed area covered by the at least one transmission beam and the at least one reflection beam based on the first installation information and the second installation information.

The at least one processor may further cause the base station to perform: providing a service to a terminal; estimating a location of the terminal; identifying an interruption of the service for the terminal; identifying that the terminal exists in one shadowed area among the at least one shadowed area; selecting one transmission beam of the at least one transmission beam and one reflection beam of the at least one reflection beam, which cover the one shadowed area; and transmitting a signal to the terminal via the RIS based on the selected one transmission beam and the selected one reflection beam.

In the transmitting of the signal to the terminal via the RIS based on the selected one transmission beam and the selected one reflection beam, the at least one processor may further cause the base station to perform: identifying a codebook based on the selected one transmission beam and the selected one reflection beam; transmitting the identified codebook to the RIS controller; and transmitting the signal to the RIS using the selected one transmission beam.

In the selecting of the one transmission beam of the at least one transmission beam and the one reflection beam of the at least one reflection beam, which cover the one shadowed area, the at least one processor may further cause the base station to perform: transmitting, to the RIS controller, 1-bit discrete phase shift codebooks related to the selected one transmission beam; transmitting, to the RIS, first reference signals related to the 1-bit discrete phase shift codebooks; receiving, from the terminal, information on first received signal qualities for the first reference signals; identifying one first reference signal of the first reference signals, which has a best received signal quality, based on the first received signal qualities; identifying one 1-bit discrete phase shift codebook corresponding to the identified one first reference signal; and selecting a reflection beam related to the identified one 1-bit discrete phase codebook as the selected one reflection beam.

According to the present disclosure, the base station can design a codebook without significantly increasing the complexity of RIS reflection beam design. Additionally, the base station can enhance the accuracy of RIS reflection beamforming and improve coverage distance. As a result, the RIS can cover wider shadowed areas and enhance communication performance for each user. Furthermore, by collecting information on RIS reflection areas in advance, communication disruptions can be addressed more quickly. This approach is expected to improve the performance of networks utilizing RIS.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a conceptual diagram illustrating exemplary embodiments of a communication system including a reconfigurable intelligent surface.

FIG. 4 is a conceptual diagram illustrating exemplary embodiments of shadowed areas that can be covered by reflection beams from an RIS according to a codebook.

FIG. 5A and FIG. 5B are flowcharts illustrating exemplary embodiments of a method for determining shadowed areas that can be covered through an RIS by the base station.

FIG. 6A and FIG. 6B are flowcharts illustrating exemplary embodiments of a beam configuration method for an RIS.

FIG. 7 is a conceptual diagram illustrating variation of reflection coefficient values.

FIG. 8 is a conceptual diagram illustrating design of a 1-bit codebook.

FIG. 9 is a conceptual diagram illustrating design of a 2-bit codebook.

FIG. 10 is a conceptual diagram illustrating exemplary embodiments of codebook-based RIS reflection beams with 1-bit discrete phase shift values.

FIG. 11 is a conceptual diagram illustrating exemplary embodiments of codebook-based RIS reflection beams with 2-bit discrete phase shift values.

FIG. 12 is a conceptual diagram illustrating exemplary embodiments of a codebook based on multiple reflection elements.

FIG. 13 is a conceptual diagram illustrating exemplary embodiments of a codebook based on a plurality of reflection elements.

FIG. 14 is a sequence chart illustrating exemplary embodiments of beam configuration by applying a 1-bit phase shift codebook.

FIG. 15 is a conceptual diagram illustrating exemplary embodiments of reflection patterns according to a 1-bit phase shift codebook.

FIG. 16 is a sequence chart illustrating exemplary embodiments of beam configuration by applying a 2-bit phase shift codebook.

FIG. 17 is a conceptual diagram illustrating exemplary embodiments of reflection patterns according to a 2-bit phase shift codebook.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

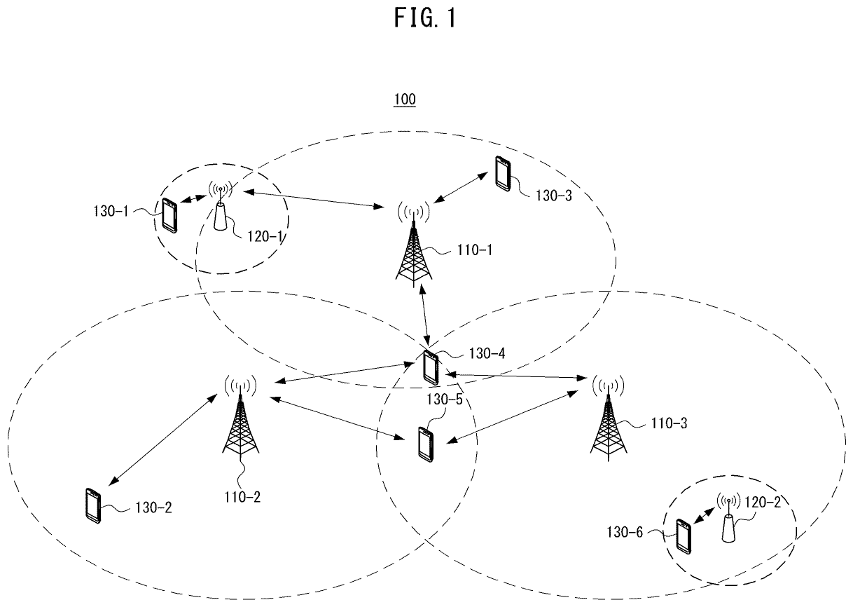

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’. Each of the plurality of communication nodes may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, orthogonal frequency division multiple access (OFDMA) based communication protocol, single-carrier FDMA (SC-FDMA) based communication protocol, non-orthogonal multiple access (NOMA) based communication protocol, space division multiple access (SDMA) based communication protocol, or the like. Each of the plurality of communication nodes may have the following structure.

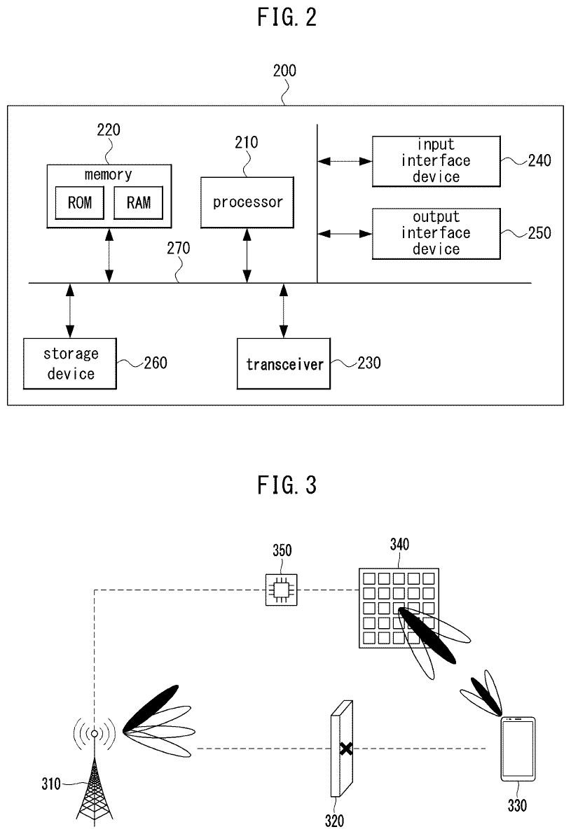

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270. However, the respective components included in the communication node 200 may be connected not to the common bus 270 but to the processor 210 through an individual interface or an individual bus. For example, the processor 210 may be connected to at least one of the memory 220, the transceiver 230, the input interface device 240, the output interface device 250, and the storage device 260 through dedicated interfaces.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), 5G Node B (gNB), base transceiver station (BTS), radio base station, radio transceiver, access point (AP), access node, road side unit (RSU), digital unit (DU), cloud digital unit (CDU), radio remote head (RRH), radio unit (RU), transmission point (TP), transmission and reception point (TRP), relay node, or the like. Each of the plurality of terminals 130-1, 130-2, 130-3, 130-4, 130-5, and 130-6 may be referred to as terminal, access terminal, mobile terminal, station, subscriber station, mobile station, portable subscriber station, node, device, or the like.

Each of the plurality of communication nodes 110-1, 110-2, 110-3, 120-1, 120-2, 130-1, 130-2, 130-3, 130-4, 130-5, and 130-6 may support cellular communication (e.g., LTE, LTE-Advanced (LTE-A), New Radio (NR), etc.). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Each of the plurality of base stations 110-1, 110-2, 110-3, 120-1, and 120-2 may support OFDMA-based downlink (DL) transmission, and SC-FDMA-based uplink (UL) transmission. In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (COMP) transmission, a carrier aggregation (CA) transmission, a transmission in unlicensed band, a device-to-device (D2D) communication (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

Meanwhile, millimeter-wave (mmWave) communication may be one of the core technologies in 5G communication systems. Due to a wider signal bandwidth, millimeter waves can achieve higher data rates and higher spectral efficiency. However, millimeter waves may experience severe path loss and blockage of line of sight between communication devices. A reconfigurable intelligent surface (RIS) may be a technology designed to improve the performance of such millimeter-wave wireless communications.

The RIS may be a planar surface composed of multiple passive reflection elements, which may flexibly reconfigure a wireless channel between a transmitter and receiver by independently adjusting and reflecting an amplitude or phase of signals incident on each reflection element. This can enhance a quality of received signals and reduce interference between signals, representing a new form of antenna technology. Additionally, the RIS can enhance spectral efficiency at low cost, expand communication coverage, and cover shadowed areas by programming cell-based metasurfaces composed of reconfigurable reflection elements to artificially reconfigure a wireless propagation environment. Therefore, the RIS may be considered a key candidate technology for 5G-Advanced and 6G communication systems.

In mobile communication systems, the RIS may primarily aim to enhance a quality of received signals by steering incident signals toward the receiver through optimal reflection beams. Thus, the RIS may require a reflection pattern that provides the optimal reflection beams. Accordingly, RIS optimization may be performed to find configuration values for the respective elements of the reflection surface to configure the reflection pattern that provides the optimal reflection beams.

In general, a method for finding the optimal RIS reflection pattern may involve measuring a signal quality of an end-to-end link between a base station and a terminal for each RIS reflection pattern to identify the one with optimal performance. However, evaluating the optimal values for all RIS reflection elements may cause significant delays in RIS beam configuration and increase system complexity.

Specifically, as the number of RIS elements increases, configuration values for the RIS reflection elements may grow exponentially. Therefore, such methods may be difficult to apply in actual communication systems. To reduce system complexity, the RIS may operate by configuring RIS beams using a codebook composed of specific phase shift values, which provide a few candidate beams.

One of the primary limitations of typical RIS is the inability to apply continuous phase shift values. As a result, the RIS may configure the reflection surface using discrete phase shift values, where a 360-degree phase is quantized to have a set of representative phase values. Consequently, this may impose constraints on the beamforming performance of RIS. A discrete phase shift-based RIS may achieve more accurate phase shifts by using a higher number of bits. However, the cost and complexity of hardware design may increase proportionally with the number of control bits. Such RIS may be designed to satisfy the trade-off between accuracy, cost, and complexity.

For example, when considering an RIS with N reflection elements, the number of cases for finding the optimal phase shift values using a 1-bit phase shift may be 2N, where N is a positive integer. When using a 2-bit phase shift for an RIS with N reflection elements, the number of cases for finding the optimal phase shift values may be 4N.

Therefore, the RIS may practically configure codebook-based reflection beams designed to have several reflection directions for beams incident on the RIS. In such cases, the beamforming accuracy and coverage distance may vary depending on combinations of beamwidth and beam direction generated from codebooks consisting of 1-bit and 2-bit phase shift values.

Assuming the same number of reflection beams, compared to a reflection area covered by reflection beams based on a 1-bit phase shift codebook, a reflection area covered by reflection beams based on a 2-bit phase shift codebook may be narrower, and more reflection beams may be required to cover the same reflection area. From the perspective of implementation complexity and cost, both codebook-based reflection beams may be trained. During a process of configuring the optimal beams, reflection beams based on the 2-bit phase shift codebook may cause more time delays for beam searching and may use more radio resources.

The present disclosure provides a codebook-based RIS beam configuration method to compensate for the trade-off between performance degradation and complexity in codebook-based RIS. Additionally, the present disclosure provides a method for quickly capturing an RIS reflection area and establishing communication services based on reflection beamforming characteristics formed by reflection coefficients derived from limited discrete-level phase shift values.

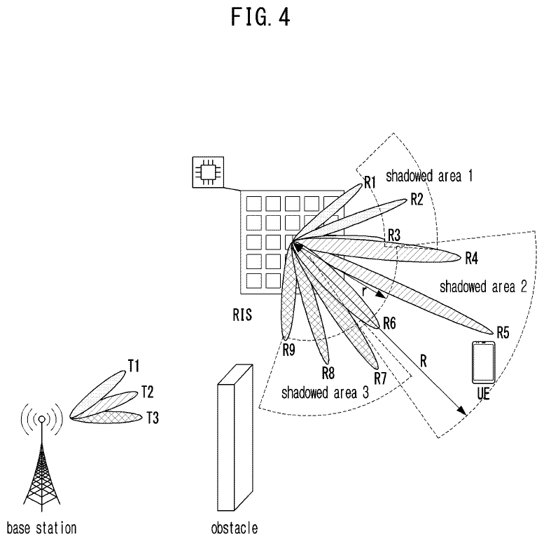

FIG. 3 is a conceptual diagram illustrating exemplary embodiments of a communication system including a reconfigurable intelligent surface.

Referring to FIG. 3, a communication system may include a base station 310, a terminal 330, a reconfigurable intelligent surface (RIS) 340, or an RIS controller 350. An obstacle 320 may exist in a direct path between the base station and the terminal. Due to such an obstacle, a communication interruption may occur due to signal blockage caused by a severe path loss. Particularly in mobile communication systems that use a frequency band with a short wavelength, such as millimeter waves, a communication interruption caused by obstacles may occur due to signal blockage resulting from a severe path loss. Here, the RIS may have N reflection elements, where N may be a positive integer.

When the base station transmits a signal, it may be difficult for the terminal to receive the signal transmitted by the base station if an obstacle is present. Therefore, the base station may transmit the signal by avoiding the obstacle. To avoid the obstacle, the base station may use the RIS. The RIS may change a transmission path of the signal between the base station and the terminal. In other words, the RIS may form a reflection path between the base station and the terminal to reflect the signal. The base station may transmit the signal to the terminal based on a channel between the base station and the RIS and a channel from the RIS to the terminal.

A vector for the channel between the base station and the RIS may be referred to as f. Additionally, a channel by the i-th reflection element of the RIS may be referred to as fᵢ. A vector for the channel from the RIS to the terminal may be referred to as g. A channel by the i-th reflection element of the RIS may be referred to as gᵢ. The base station may identify the channel between the base station and the RIS and the channel from the RIS to the terminal through the following procedure. Here, i may be a positive integer, and 1≤i≤N.

If uplink and downlink are distinguished by time-division multiplexing, a downlink channel may be estimated based on an uplink channel. For example, it may be assumed that the terminal transmits a pilot signal to the base station. Additionally, it may be assumed that the RIS activates only the i-th reflection element among its elements. The RIS may deactivate the remaining reflection elements excluding the i-th reflection element. Here, the pilot signal transmitted by the terminal may be transmitted to the i-th reflection element of the RIS. The i-th reflection element of the RIS may reflect the pilot signal transmitted by the terminal and transmit it to the base station.

Thus, the base station may receive the pilot signal transmitted by the terminal. The base station may estimate the channel based on the received pilot signal. The pilot signal transmitted by the terminal may be transmitted through the channel between the base station and the RIS and the channel from the RIS to the terminal. Additionally, the pilot signal transmitted by the terminal may be transmitted to the base station via the uplink. Therefore, the base station may estimate the channel represented by a product of fᵢ and gᵢ based on the pilot signal.

In other words, the base station may estimate the downlink channel based on the uplink channel. Additionally, the base station and the terminal may estimate the channel represented by the product of fᵢ and gᵢ for all reflection elements of the RIS. At this time, the channel represented by the product of fᵢ and gᵢ may be referred to as a channel fᵢgᵢ.

Meanwhile, if the uplink and downlink are distinguished by frequency-division multiplexing, an uplink channel may be estimated based on a downlink channel. For example, the base station may transmit a pilot signal to the i-th reflection element among the reflection elements of the RIS. The i-th reflection element of the RIS may transmit the received pilot signal to the terminal. The terminal may receive the pilot signal transmitted by the i-th reflection element of the RIS. The terminal may estimate the channel fᵢgᵢ based on the signal transmitted by the base station. The terminal may transmit information on the estimated channel fᵢgᵢ to the base station. In other words, the terminal may feedback information on the channel fᵢgᵢ, which is estimated based on the downlink, to the base station. At this time, the terminal may quantize the estimated channel fᵢgᵢ before transmitting it to the base station.

The base station may transmit M transmission beams, where M may be a positive integer. Among the M transmission beams transmitted by the base station, there may be a transmission beam directed toward the RIS. This transmission beam directed toward the RIS may be referred to as a beam toward RIS. The transmission beam directed toward the RIS among the M transmission beams transmitted by the base station may be incident on the RIS. Accordingly, the transmission beam transmitted toward the RIS from the base station may be referred to as an incident beam on RIS.

The RIS may reflect the transmission beam received from the base station toward the terminal. The incident beam on RIS, reflected by the RIS, may be referred to as a reflection beam of RIS. The reflection beam from the RIS may be incident on the terminal. The terminal may receive the reflection beam from the RIS. The reflection beam from the RIS may be referred to as an incident beam on terminal.

The base station may deliver signals using the transmission beam directed toward the RIS. Accordingly, the RIS may receive the signals through the transmission beam transmitted from the base station. The RIS may transmit the signals received from the base station to the terminal using the reflection beam. The terminal may receive the signals from the RIS through the reflection beam. As such, the base station may transmit signals toward the RIS using the transmission beam toward the RIS. The RIS may receive the signals from the base station and deliver the signals to the terminal through the reflection beam. The terminal may receive the signals through the reflection beam from the RIS.

A pair of the transmission beam toward the RIS and the reflection beam of the RIS may be determined through an optimal beam selection process. Since the transmission beam toward the RIS is determined through such an optimal beam selection process, signals reaching the terminal through the remaining transmission beams transmitted by the base station may have reduced signal strengths and may fail to be received by the RIS. Additionally, since the reflection beam is determined through the optimal beam selection process, signals reaching the terminal through the remaining reflection beams from the RIS may have reduced signal strengths and may fail to be received by the terminal.

The RIS may have N reflection elements, where N may be a positive integer. The signals transmitted by the base station may be reflected by the i-th reflection element (i=1, . . . , N). When the terminal receives the signals transmitted by the base station, a two-stage cascade channel consisting of the base station-RIS channel and the RIS-terminal channel may be formed between the base station, RIS, and terminal. For example, in the case of the uplink, to determine a phase shift value of the i-th reflection element, the RIS controller may turn on only the i-th reflection element of the RIS and configure the other reflection elements to the off state, allowing the base station to estimate the channel of the signals received through the i-th reflection element. In the case of the downlink, to determine a phase shift value of the i-th reflection element, the RIS controller may turn on only the i-th reflection element of the RIS and configure the other reflection elements to the off state, allowing the terminal to estimate the channel of the signals received through the i-th reflection element.

The RIS controller may repeat the above-described process N times to estimate the channels through all reflection elements of the RIS. Based on these channel estimations, the RIS controller may configure the optimal beam of the RIS by using the phase shift values of the reflection elements corresponding to the best received signal quality. However, since this method requires estimating all possible phase shift values of the RIS reflection elements, the complexity may increase exponentially as the number of RIS reflection elements grows.

Therefore, considering actual wireless communication environments, the RIS controller may determine reflection beams capable of reflecting incident signals in specific directions, and define and manage a set of phase shift values for steering signals in specific directions as a codebook or beam-book. A phase shift combination vector θ_{m,k} for the RIS corresponding to the m-th incident beam and the k-th reflection beam may be expressed as shown in Equation 1. The phase shift combination vector θ_{m,k} for the RIS may represent the set of phase shift values that reflect the m-th incident beam, or in other words, the m-th transmission beam, in a specific direction. Here, m and k are positive integers, where 0≤m≤M and 0≤k≤K. K represents the total number of reflection beams and may be a positive integer.

$${θ}_{m , k} = {[ \begin{matrix}{w}_{1 , 1} & {w}_{1 , 2} & … & {w}_{1 , k} \\ ⋮ & ⋮ & ⋱ & ⋮ \\ {w}_{m , 1} & {w}_{m , 2} & … & {w}_{m , k}\end{matrix} ]}^{T} \qquad [ Equation 1 ]$$

Here, w_{m,k} may be a reflection coefficient vector of RIS reflection elements related to the k-th reflection beam for the m-th incident beam. The reflection coefficient vector w_{m,k} of the RIS may consist of the phase shift values for the N reflection elements. In other words, the reflection coefficient vector w_{m,k} of the RIS may be composed of the phase shift values of the N reflection elements. These phase shift values of the N reflection elements may be represented as a codebook.

A method for selecting the optimal beam using the above-described codebook may include a step of measuring a received signal quality for each set of <m-th transmission beam, k-th reflection beam>, a step of storing the signal quality values for the respective cases, and a step of selecting a beam set with the best signal quality as the optimal beam. The metrics for measuring signal quality may include Reference Signal Received Power (RSRP), Reference Signal Received Quality (RSRQ), Signal-to-Noise Ratio (SNR), and Bit Error Rate (BER).

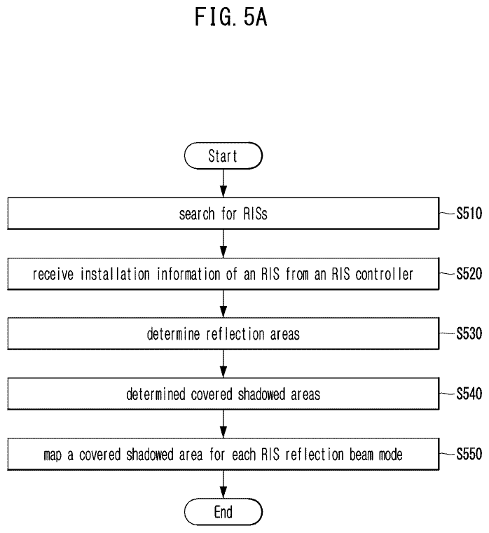

FIG. 4 is a conceptual diagram illustrating exemplary embodiments of shadowed areas that can be covered by reflection beams from an RIS according to a codebook.

Referring to FIG. 4, there may be three transmission beams from the base station. Each of the transmission beams reflected by the RIS may form a reflection pattern. Here, the reflection pattern formed by each of the transmission beams reflected by the RIS may be referred to as an RIS reflection beam mode. Three transmission beams reflected by the RIS may each form a reflection pattern. Thus, there may be three RIS reflection beam modes. For example, the RIS may reflect one transmission beam to form a reflection pattern composed of three reflection beams. In this scenario, when there are three RIS reflection beam modes, the reflection beams formed by the three transmission beams reflected from the RIS may be a total of nine beams.

A transmission beam 1 (T1) may be reflected by the RIS to form a reflection pattern composed of a reflection beam 1 (R1), a reflection beam 2 (R2), and a reflection beam 3 (R3). The reflection pattern formed by the reflection beam 1, reflection beam 2, and reflection beam 3 may be referred to as one reflection beam mode (i.e. referred to as a reflection beam mode 1).

A transmission beam 2 (T2) may be reflected by the RIS to form a reflection pattern composed of a reflection beam 4 (R4), a reflection beam 5 (R5), and a reflection beam 6 (R6). The reflection pattern formed by the reflection beam 4, reflection beam 5, and reflection beam 6 may be referred to as another reflection beam mode (i.e. referred to as a reflection beam mode 2).

A transmission beam 3 (T3) may be reflected by the RIS to form a reflection pattern composed of a reflection beam 7 (R7), a reflection beam 8 (R8), and a reflection beam 9 (R9). The reflection pattern formed by the reflection beam 7, reflection beam 8, and reflection beam 9 may be referred to as the other reflection beam mode (i.e. referred to as a reflection beam mode 3).

The terminal may be located in a shadowed area 2 among shadowed areas 1 to 3. During initial access, the terminal may receive a synchronization signal block (SSB) transmitted by the base station. In this case, the terminal may receive the SSB via the reflection beam 5, which is indicated by a set of <transmission beam 2, RIS reflection beam mode 2>. When the terminal receives the SSB through the reflection beam 5 in this manner, the terminal may achieve the best reception sensitivity. Here, the shadowed area may be formed in a sector shape, where a sector with a radius of r is subtracted from a larger sector with a radius of R centered on the RIS. R and r may be positive real numbers.

The present disclosure proposes a method for deriving shadowed areas that can be covered by transmission beams of the base station and reflection beam modes of the RIS, as well as a method for configuring the RIS reflection beam modes. For example, when considering RIS reflection beams that reflect incident beams at angles θₐ, θ_{b}, and θ_{c}, the base station may classify a shadowed area covered by the incident beam 2 as the shadowed area 2. Here, θₐ, θ_{b}, and θ_{c} may be real numbers. In another example, if the RIS can be configured to map a reflection beam to each incident beam, the RIS may be able to cover a wider shadowed area or provide more detailed support by subdividing the shadowed area.

Upon initial installation, the RIS controller may store and manage installation information of the RIS, including the RIS installation location, the number of RIS reflection elements, the types of RIS reflection beam modes, the number of reflection beams forming each RIS reflection beam mode, the beamwidth and beam direction of each reflection beam forming the RIS reflection beam mode, and the RIS azimuth. As an example, when the base station searches for available RISs in the vicinity, the base station may request installation information of RISs from the RIS controller(s). The RIS controller in the network may transmit the corresponding RIS installation information to the base station. Based on the base station's installation location and information on the beamwidths and beam directions of the transmission beams, the base station may determine the shadowed areas that each RIS can cover.

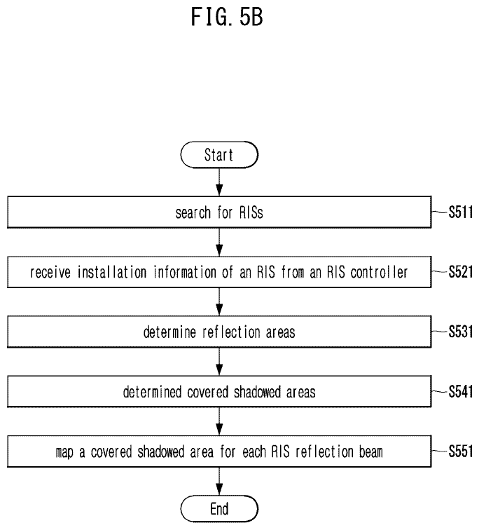

FIG. 5A is a flowchart illustrating exemplary embodiments of a method for determining shadowed areas that can be covered through an RIS by the base station.

Referring to FIG. 5A, the base station may search for RISs located nearby (S510). The base station may request installation information of the identified RISs from the corresponding RIS controller(s). The RIS controller may provide the stored RIS installation information to the base station. For example, the RIS controller may store and manage RIS installation information such as the RIS installation location, the number N of RIS reflection elements, the types p of RIS reflection beam modes, the number k of reflection beams forming each RIS reflection beam mode, the beamwidth and beam direction of each reflection beam forming the RIS reflection beam mode, and the RIS azimuth. The RIS controller may provide the base station with the RIS installation information, including the RIS installation location, the number of RIS reflection elements, the types of RIS reflection beam modes, the number of reflection beams forming each RIS reflection beam mode, the beamwidth and beam direction of each reflection beam forming the RIS reflection beam mode, and the RIS azimuth. The base station may receive the RIS installation information from the RIS controller, including the RIS installation location, the number of RIS reflection elements, the number of RIS reflection beam mode types, the number of reflection beams forming each RIS reflection beam mode, the beamwidth and beam direction of each reflection beam forming the RIS reflection beam mode, and the RIS azimuth (S520).

The base station may determine a reflection area for each transmission beam and each RIS reflection beam mode by considering the RIS installation information received from the RIS controller and the base station's installation information (S530). Here, the base station installation information may include the installation location of the base station, the number of transmission beams, and the beamwidth and beam direction of each transmission beam m. The reflection area may be a sector area with a radius R centered on the RIS.

The base station may determine a covered shadowed area based on the reflection area for each transmission beam and each RIS reflection beam mode determined using the RIS installation information and the base station installation information (S540). Here, the covered shadowed area may be formed in a sector shape, where a sector with a radius of r is subtracted from a larger sector with a radius of R centered on the RIS (see FIG. 4). The base station may generate a mapping table by mapping information such as an RIS identifier (ID), information on the transmission beam m (e.g. ID of the transmission beam), information on an RIS reflection beam mode p (e.g. ID of the RIS reflection beam mode), information on a reflection beam k of the RIS reflection beam mode (e.g. ID of reflection beam k), and information on the covered shadowed area q (e.g. location information of the covered shadowed area) (S550). Here, m, p, and k may be positive integers, and p may equal m. R and r may be positive real numbers. The base station may store and manage the mapping table of transmission beams, reflection beam modes, reflection beams of reflection beam modes, and covered shadowed areas in a memory or similar storage. This may be managed in conjunction with beam management of the base station and RIS beam management. Here, the management mapping table of transmission beams, reflection beam modes, reflection beams of reflection beam modes, and covered shadowed areas may represent management information for these components.

Meanwhile, the terminal may connect to the base station. Accordingly, the base station may provide a communication service to the terminal. In such a situation, a communication interruption may occur between the base station and the terminal. The base station may quickly reconnect communication with the terminal through the RIS path while minimizing time delay by identifying the terminal's shadowed area based on distance/angle and location information of the base station.

Here, the base station may determine shadowed area(s) covered by a reflection mode and configure a mapping table. Alternatively, the base station may determine shadowed area(s) covered by a reflection beam and configure a mapping table. To this end, the base station may determine a reflection area for each transmission beam and each of the reflection beams in the RIS reflection beam mode by considering the installation information of the RIS received from the RIS controller and the installation information of the base station. Such reflection area (determined by the reflection beam) may be narrower than a reflection area determined by the reflection mode and may be included in the reflection area determined by the reflection mode, and thus may be referred to as a sub-reflection area.

The base station may determine a covered shadowed area based on the reflection area of each transmission beam and each reflection beam in the RIS reflection beam mode, determined based on the installation information of the RIS and the installation information of the base station. This covered shadowed area may be narrower than the covered shadowed area based on the reflection mode and may be included in the covered shadowed area determined based on the reflection mode, and thus may be referred to as a sub-covered shadowed area.

The base station may form a management mapping table by mapping the RIS ID, information on transmission beam m (e.g. ID of the transmission beam), information on reflection beam k of the transmission beam (e.g. ID of the reflection beam k of the transmission beam), and information on the covered shadowed area q (e.g. location information of the covered shadowed area). Here, m, k, and q may be positive integers. The base station may manage the mapping table of the transmission beam, reflection beam, and covered shadowed area by storing it in a memory and managing it in conjunction with the beam management of the base station and the beam management of the RIS. Here, the management mapping table of the transmission beam, reflection beam, and covered shadowed area may be management information of the transmission beam, reflection beam, covered shadowed area, etc.

The method of determining the shadowed area based on FIG. 5A may determine the shadowed area based on the reflection mode and determine the shadowed area for each of the reflection beams constituting the reflection mode. Alternatively, as can be seen in FIG. 5B, the base station may determine the shadowed area for each reflection beam directly without relying on the reflection mode.

FIG. 5B is a flowchart illustrating exemplary embodiments of a method for determining a shadowed area that can be covered through an RIS by the base station.

Referring to FIG. 5B, the base station may search for RISs located nearby (S511). The base station may request installation information of the identified RISs from the corresponding RIS controller(s). Then, the RIS controller may provide the base station with the installation information of the RISs that the RIS controller stores and manages. For example, the RIS controller may store and manage RIS installation information, including RIS installation location, the number N of RIS reflection elements, the number k of reflection beams for each transmission beam, the beamwidth and beam direction of each reflection beam for each transmission beam, and an azimuth angle of the RIS. The RIS controller may provide the base station with RIS installation locations, the number of RIS reflection elements, the number of reflection beams for each transmission beam, the beamwidth and beam direction of each reflection beam for each transmission beam, and the azimuth angle of the RIS. The base station may receive the RIS installation information, including RIS installation locations, the number of RIS reflection elements, the number of reflection beams for each transmission beam, the beamwidth and beam direction of each reflection beam for each transmission beam, and the azimuth angle of the RIS, from the RIS controller (S521).

The base station may determine a reflection area for each RIS reflection beam by considering the RIS installation information received from the RIS controller and the base station installation information (S531). Here, the base station installation information may include the installation location of the base station, the number of transmission beams of the base station, and the beamwidth and beam direction of each transmission beam m of the base station. The reflection area may be a sector area having a radius R centered on the RIS. Such reflection area (determined by the each reflection beam) may be a narrower area than the reflection area determined in FIG. 5A and may be included in the reflection area determined in FIG. 5A, thus being referred to as a sub-reflection area.

The base station may determine a covered shadowed area based on the reflection area of each RIS reflection beam determined based on the RIS installation information and the base station installation information (S541). Here, the covered shadowed area may be formed in a sector shape, where a sector with a radius of r is subtracted from a larger sector with a radius of R centered on the RIS (see FIG. 4). The covered shadowed area may be a narrower area than the shadowed area determined in FIG. 5A and may be included in the shadowed area determined in FIG. 5A, thus being referred to as a sub-covered shadowed area.

The base station may form a management mapping table by mapping the RIS identifier (ID), transmission beam m, reflection beam k, and shadowed area q (S551). Here, m, k, and q may be positive integers. R and r may be positive real numbers. The base station may store and manage the formed management mapping table of transmission beams, reflection beams, and shadowed area in a memory and may manage it in conjunction with beam management of the base station and beam management of the RIS. Here, the management mapping table of transmission beams, reflection beams, and shadow regions may be management information of transmission beams, reflection beams, and shadowed areas.

Meanwhile, the terminal may connect to the base station. Accordingly, the base station may provide a communication service to the terminal. In such a situation, a communication interruption may occur between the base station and the terminal. The base station may identify a shadowed area of the terminal based on distance/angle and location information of the base station to quickly reconnect communication with the terminal via the RIS path while minimizing time delay.

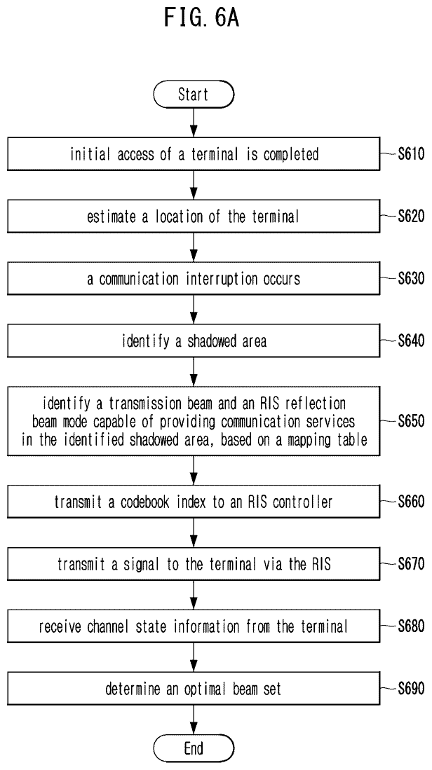

FIG. 6A is a flowchart illustrating exemplary embodiments of a beam configuration method for an RIS.

Referring to FIG. 6A, a terminal may initially access a base station. When the initial access of the terminal is completed (S610), the base station may identify an angle of arrival (AoA) of signals received from the terminal and estimate a location of the terminal by determining a distance between the base station and the terminal (S620). A communication interruption may occur in a direct path between the base station and the terminal (S630). In such a case, after the initial access, the base station may identify the location of the terminal based on the AoA, distance, and other information estimated in the connected state of the terminal. Based on the identified location of the terminal, the base station may determine a shadowed area in which the terminal is located (S640).

When the shadowed area where the terminal is located is identified, the base station may identify an RIS capable of covering the identified shadowed area, a transmission beam of the RIS, and a reflection beam mode of the RIS in the management mapping table (S650). The base station may transmit a codebook or codebook index corresponding to the information <base station transmission beam, RIS reflection beam mode> of the identified RIS to the RIS controller of the identified RIS (S660).

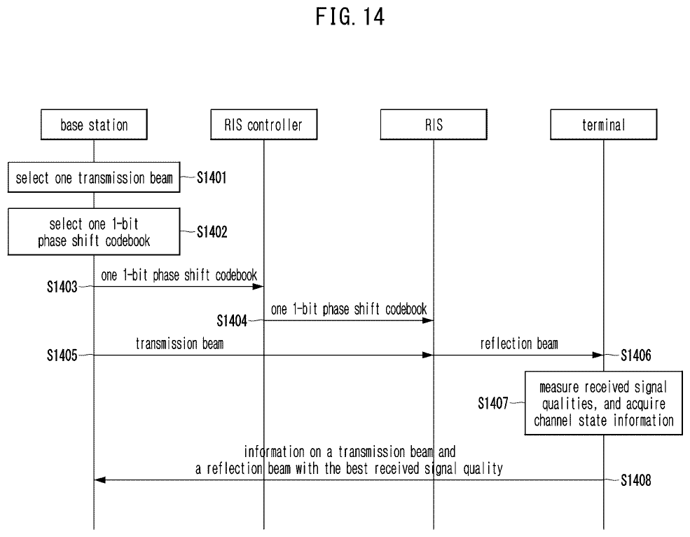

The RIS controller may receive the codebook or codebook index from the base station and deliver the received codebook or codebook index to the RIS. The RIS may receive the codebook or codebook index from the RIS controller. The base station may transmit a reference signal to the RIS using the identified transmission beam. The RIS may reflect the transmission beam received from the base station toward the terminal according to the received codebook or codebook index. The terminal may receive the reference signal from the base station via the RIS (S670). Then, the terminal may measure a channel state based on the received reference signal and transmit the measured channel state information to the base station via the RIS. Here, the channel state information may be a received signal quality. Then, the base station may receive the channel state information from the terminal (S680). The base station may configure an optimal beam set, including a transmission beam and RIS reflection beam mode with the best received signal quality, based on the received channel state information (S690). The base station may configure the optimal beam set, including the transmission beam and the RIS reflection beam mode with the best received signal quality, by referring to FIGS. 14 to 17 for steps S650 to S680.

FIG. 6B is a flowchart illustrating exemplary embodiments of a beam configuration method for an RIS.

Referring to FIG. 6B, a terminal may initially access a base station. When the initial access of the terminal is completed (S611), the base station may identify an angle of arrival (AoA) of signals received from the terminal and estimate a location of the terminal by determining a distance between the base station and the terminal (S621). A communication interruption may occur in a direct path between the base station and the terminal (S631). In such a case, after the initial access, the base station may identify the location of the terminal based on the information, such as the AoA and distance of the terminal, estimated while in the connected state. The base station may determine a shadowed area in which the terminal is located based on the determined location of the terminal (S641).

When the shadowed area where the terminal is located is identified, the base station may identify an RIS capable of covering the identified shadowed area, a transmission beam of the RIS, and a reflection beam of the RIS in the management mapping table (S651). The base station may transmit a codebook or codebook index corresponding to the information <base station transmission beam, RIS reflection beam > of the identified RIS to the RIS controller of the identified RIS (S661).

The RIS controller may receive the codebook or codebook index from the base station and deliver the received codebook or codebook index to the RIS. The RIS may receive the codebook or codebook index from the RIS controller. The base station may transmit a reference signal to the RIS using the identified transmission beam. The RIS may reflect the transmission beam received from the base station toward the terminal according to the received codebook or codebook index. The terminal may receive the reference signal from the base station via the RIS (S671). Then, the terminal may measure a channel state based on the received reference signal and transmit the measured channel state information to the base station via the RIS. Here, the channel state information may be a received signal quality. Then, the base station may receive the channel state information from the terminal (S681). The base station may configure an optimal beam set, including a transmission beam and RIS reflection beam with the best received signal quality, based on the received channel state information (S691). The base station may configure the optimal beam set, including the transmission beam and the RIS reflection beam with the best received signal quality, by referring to FIGS. 14 to 17 for steps S651 to S681.

Meanwhile, the present disclosure proposes an RIS codebook configuration method that hierarchically configures RIS reflection beams using low bits and high bits for a codebook-based RIS having discrete phase shifts. The RIS may change the phases of signals by adjusting an impedance of each element to reflect the received signals in a desired direction.

Similarly to the principle of beamforming, by ensuring that signals reflected through the RIS are combined with the same phase in a specific direction, the direction of the incident signals may be altered to reach the terminal in the desired direction. In this case, the RIS may configure the reflection elements to steer the signals toward the specific direction. This may require a process to identify a set of reflection coefficients for the reflection elements that results in the best signal quality at the receiver receiving the reflected signals. In other words, it may require identifying a reflection coefficient vector that forms the RIS reflection optimal beam.

The beamforming procedure in the RIS may be conducted based on the channels fᵢgᵢ In this case, the terminal may receive signals from the respective reflection elements of the RIS. The signals received by the terminal may have the same phase. The terminal may perform beamforming by combining the signals with the same phase. The terminal may demodulate the signals transmitted by the base station based on the performed beamforming. During the demodulation of the signals transmitted by the base station, the terminal may maximize the signal-to-noise ratio (SNR).

To maximize the SNR of the demodulated signals, the phases of the signals incoming to the terminal through the RIS may need to be the same. Additionally, to maximize the SNR of the demodulated signal, the reflection coefficients of the reflection elements of the RIS may need to have large values. In this case, the reflection coefficient of the i-th reflection element may be expressed as Equation 2.

$${β}_{i} = {e}^{j {θ}_{i}} \qquad [ Equation 2 ]$$

θᵢ may represent the phase shift value of the i-th reflection element of the RIS and may be a real number. βᵢ may represent the reflection coefficient of the i-th reflection element and may be a real number. e may denote the exponential function. j may represent an imaginary number. The reflection coefficients of the respective reflection elements may have the same value of 1. Furthermore, the phases of the signals reflected by the respective reflection elements may vary according to the phase of the channel. The variation of the phase of the signals reflected by the i-th reflection element according to the channel phase may be expressed as Equation 3.

$${θ}_{i} = - angle \{ {f}_{i} {g}_{i} \} \qquad [ Equation 3 ]$$

angle {fᵢgᵢ} may represent the phase shift of the channel. In this case, it may be difficult for the base station to transmit continuous phase shift values for the reflection elements of the RIS. Therefore, the base station may define a set of specific phase shift values for the reflection elements of the RIS. The set of specific phase shift values may be referred to as a codebook. The base station may transmit the codebook to the RIS controller. The RIS controller may generate the phase shifts of the reflection elements of the RIS based on the codebook received from the base station.

The codebook may be designed using a quantization scheme that allows discrete phase shift values for the respective reflection elements. Here, the quantization scheme may include an element-by-element quantization scheme. For example, if 1-bit quantization is considered for each reflection element, the codebook may be designed as βᵢ={1 or −1}, that is, θᵢ={0, π}. Additionally, in the case of 2-bit quantization, the codebook may be designed as βᵢ={1, j, −1 or −j}, that is,

$${θ}_{i} = \{ 0 , \frac{π}{2} , π , \frac{3 π}{2} \} .$$

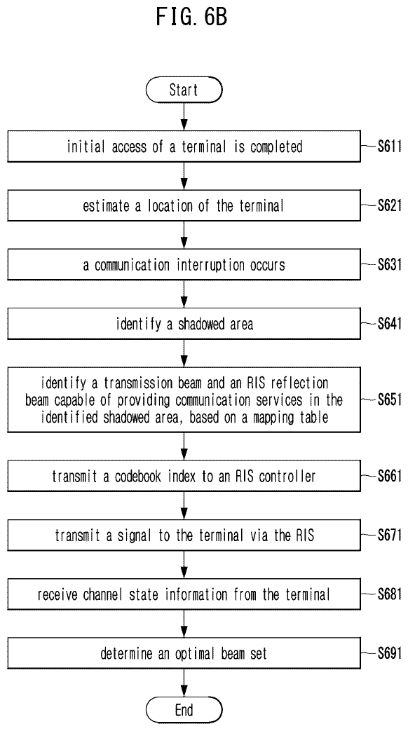

FIG. 7 is a conceptual diagram illustrating variation of reflection coefficient values.

Referring to FIG. 7, the reflection coefficient values for the reflection elements of the RIS may vary. Therefore, when considering the variation of the reflection coefficient values, the reflection coefficient may be expressed as Equation 4.

$${β}_{i} = {β}_{i} ( {θ}_{i} ) {e}^{j {θ}_{i}} \qquad [ Equation 4 ]$$

Here, βᵢ (θᵢ) may not be equal to 1 depending on the value of θᵢ and may be a real number. Therefore, when each reflection element of the RIS determines θᵢ based on the channel information gᵢfᵢ, βᵢ (θᵢ) may vary depending on the phase shift value θᵢ of the reflection element. The base station may calculate the reflection coefficients reflecting the variation of reflection coefficient values during the process of designing the codebook. The reflection coefficient values according to the phase shifts may be expressed as Equation 5.

$${β}_{i} ( {θ}_{i} ) = ( 1 - {β}_{min} ) {( \frac{sin ( {θ}_{i} - ϕ ) + 1}{2} )}^{α} + {β}_{min} \qquad [ Equation 5 ]$$

βᵢ (θᵢ) may represent the reflection coefficient value according to the phase shift value. βₘᵢₙ may represent the minimum value of the reflection coefficient and may be a real number. ϕ may represent a phase shift difference between

$$- \frac{π}{2}$$

and βₘᵢₙ, and may be a real number. α may represent a phase shift change rate and may be a real number.

Therefore, the present disclosure proposes a method of designing a codebook reflecting the characteristics of varying reflected signal forms according to the values of βₘᵢₙ, ϕ, and α. When the base station uses an arbitrary RIS for the first time, the base station may first identify the characteristics of reflection coefficient value variations according to the phase shifts of the reflection elements of the RIS. The base station may then perform an initialization procedure or a calibration procedure. The calibration procedure may include a process of identifying the characteristics of reflection coefficient value variations according to the phase shifts of the reflection elements and a process of designing the codebook reflecting the characteristics of reflection coefficient value variations.

The base station may transmit a pilot signal to the RIS. The RIS may reflect the pilot signal toward the terminal. The terminal may estimate the channel based on the received pilot signal. The terminal can transmit the estimated channel information to the base station. The base station may generate parameter information based on the channel information transmitted by the terminal. Therefore, the base station may identify the parameters based on the transmitted pilot signal. The parameters may include at least one of βₘᵢₙ, ϕ, or α. The parameters βₘᵢₙ, ϕ, and α may alter βᵢ (θᵢ).

Meanwhile, the base station may perform a calibration procedure. The base station may transmit pilot signals to the RIS while varying the phase shift values of the pilot signals. The base station may estimate the cascaded channels based on the pilot signals transmitted to the RIS. The cascaded channel may represent βᵢfᵢgᵢ. The base station may determine optimal parameters through schemes such as curve fitting based on test data. The test data may represent the cascaded channels estimated by the base station. The optimal parameters may represent βₘᵢₙ, ϕ, and α corresponding to the highest cascaded channel value obtained through the curve fitting scheme.

The base station may determine the characteristics of specific reflection elements of the RIS through the calibration procedure. Once the base station determines the characteristics of specific reflection elements of the RIS, the base station may communicate with the terminal using the RIS. The calibration procedure may be performed when the base station uses the RIS for the first time or when the base station changes the previously used RIS.

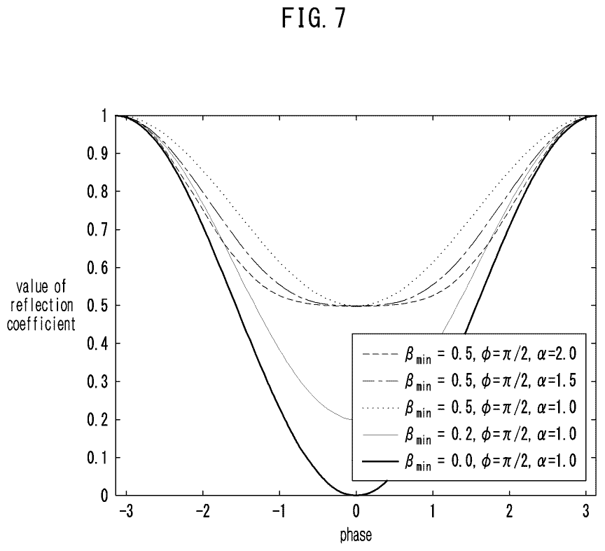

FIG. 8 is a conceptual diagram illustrating design of a 1-bit codebook.

Referring to FIG. 8, the value of the reflection coefficient may vary according to the phase shift of the signal. Additionally, the value of the reflection coefficient may differ depending on two values of ϕ. ϕ may be used to configure the codebook. For example, the phase shift combinations of the 1-bit codebook may be {0, π} 810 and

$$\{ - \frac{π}{2} , \frac{π}{2} \} 820.$$

When the phase combination of the codebook is {0, π}, βₘᵢₙ may be 0.5, and the phase of βₘᵢₙ may be π/2. Accordingly, the value of ϕ may be 0. Additionally, when the phase combination of the codebook is

$$\{ - \frac{π}{2} , \frac{π}{2} \} ,$$

βₘᵢₙ may be 0.5, and the phase of βₘᵢₙ may be 0. The value of ϕ may be π/2.

When ϕ is π/2, the 1-bit codebook may use the phase variation combination of {0, π} (811 and 813). Here, the value of the reflection coefficient may vary between 1 and 0.5 depending on the phase shift selection. The base station may design the codebook by shifting it by π/2. When ϕ is π/2, the 1-bit codebook may use the phase combinations of

$$\{ - \frac{π}{2} , \frac{π}{2} \} ( 821 and 823 ) .$$

Here, regardless of the phase selection, the value of the reflection coefficient may be consistently 0.75 (821 and 823). Accordingly, the base station may generate the codebook with minimal performance variation depending on the phase of the signal.

On the other hand, when ϕ is 0, the 1-bit codebook may use the phase combination of {0, Tt} (812 and 814). Regardless of the phase selection, the value of the reflection coefficient may be consistently 0.75. The base station may design the codebook by shifting it by π/2. When ϕ is 0, the 1-bit codebook may use the phase combination of

$$\{ - \frac{π}{2} , \frac{π}{2} \} ( 822 and 824 ) .$$

Depending on the phase selection, the value of the reflection coefficient may vary between 1 and 0.5. Accordingly, when ϕ is 0, the base station may maintain consistent performance by using the 1-bit codebook for the phase combination of {0, π}. In other words, when using the 1-bit codebook, the base station may uniformly adjust the reflection coefficients of the reflection elements of the RIS by shifting the entire codebook.

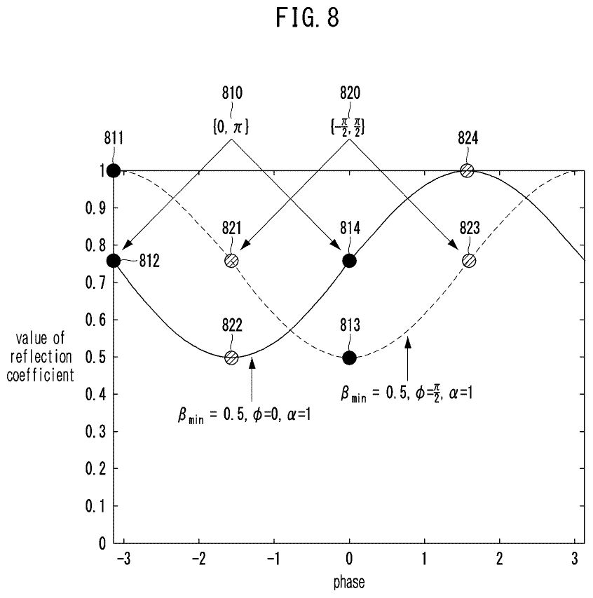

FIG. 9 is a conceptual diagram illustrating design of a 2-bit codebook.

Referring to FIG. 9, the value of the reflection coefficient may vary according to the phase variation of the signal. Additionally, the value of the reflection coefficient may differ depending on four values of @. Unlike the 1-bit codebook, the 2-bit codebook may be designed to minimize phase shift differences as much as possible. The 2-bit codebook may have 90-degree intervals. Accordingly, the base station may design a 2-bit codebook with four phase shifts. The 2-bit codebook may have a phase shift combination of {0, π/2, π, 3π/2}. Alternatively, the 2-bit codebook may have a phase shift combination of

$$\{ - \frac{3 π}{4} , - \frac{π}{4} , \frac{π}{4} , \frac{3 π}{4} \} .$$

Therefore, the phase variation combinations of the 2-bit codebook may be {0, π/2, π, 3π/2} 910 and

$$\{ - \frac{3 π}{4} , - \frac{π}{4} , \frac{π}{4} , \frac{3 π}{4} \} 920.$$

When the phase shift combination of the codebook is {0, π/2, π, 3π/2}, βₘᵢₙ may be 0.5, and the phase shift of βₘᵢₙ may be 0. Accordingly, the value of ϕ may be π/2. Additionally, when the phase shift combination of the codebook is

$$\{ - \frac{3 π}{4} , - \frac{π}{4} , \frac{π}{4} , \frac{3 π}{4} \} ,$$

βₘᵢₙ may be 0.5, and the phase shift of βₘᵢₙ may be

$$- \frac{π}{4} .$$

Accordingly, the value of ϕ may be π/4.

When ϕ is π/2, the 2-bit codebook may use the phase shift combination of {0, π/2, π, 3π/2} (911, 913, 915, 917). Here, the value of the reflection coefficient may vary between 1 and 0.5 depending on the phase shift selection. The base station may design the codebook by shifting it by π/4. The 2-bit codebook may use the phase shift combinations of

$$\{ - \frac{3 π}{4} , - \frac{π}{4} , \frac{π}{4} , \frac{3 π}{4} \} 920.$$

Here, the value of the reflection coefficient may be greater than 0.5 and less than 1.0 depending on the phase shift selection. Accordingly, when using the phase shift combinations of

$$\{ - \frac{3 π}{4} , - \frac{π}{4} , \frac{π}{4} , \frac{3 π}{4} \} 920 ,$$

the 2-bit codebook may generate the codebook with less performance variation compared to the phase shift combinations of {0, π/2, π, 3π/2} 910.

When ϕ is π/4, the 2-bit codebook may use the phase shift combination of {0, π/2, π, 3π/2} (912, 914, 916, 918). Here, the value of the reflection coefficient may be greater than 0.5 and less than 1.0 depending on the phase shift selection. Additionally, the base station may design the codebook by shifting it by π/4. The 2-bit codebook may use the phase shift combination of

$$\{ - \frac{3 π}{4} , - \frac{π}{4} , \frac{π}{4} , \frac{3 π}{4} \} ( 920 ) .$$

Here, the value of the reflection coefficient may be equal to or greater than 0.5 and less than 1.0 depending on the phase shift selection. Accordingly, when using the phase shift combination of {0, π/2, π, 3π/2}, the 2-bit codebook may generate the codebook with less performance variation compared to the phase shift combination of

$$\{ - \frac{3 π}{4} , - \frac{π}{4} , \frac{π}{4} , \frac{3 π}{4} \} ( 920 ) .$$

In other words, when ϕ is π/2, the 2-bit codebook may exhibit less performance variation depending on the phase shift combination of

$$\{ - \frac{3 π}{4} , - \frac{π}{4} , \frac{π}{4} , \frac{3 π}{4} \} .$$

Additionally, when ϕ is π/4, the 2-bit codebook may exhibit less performance variation depending on the phase shift combination of {0, π/2, π, 3π/4}.

The RIS may adjust the phase component of the RIS reflection coefficient to have a phase shift value. The optimal reflection coefficient may have a continuous phase shift value. However, considering hardware design and implementation complexity, the phase shifts of actual RIS reflection elements may be discretized into L levels over the 360-degree phase by quantizing continuous phase shift values. Here, L may be a positive integer.

As described above, a discrete phase shift-based RIS may achieve higher accuracy in phase shift as more bits are used to represent the phase shift value of the reflection element. However, the cost and complexity of hardware design may increase in proportion to the number of control bits. The RIS may fix the amplitude of the reflection element to 1, and the performance of an RIS-based communication link with 1-bit or 2-bit discrete phase shift values may degrade by −3.9 dB and −0.9 dB, respectively, compared to the performance of an RIS-based communication link with optimal continuous phase shift values. However, considering the implementation elements of actual communication systems, an RIS reflection whose signal quality is insufficient to provide services to users in shadowed areas cannot be used in a system operating in multiple RIS reflection beam modes based on a codebook.

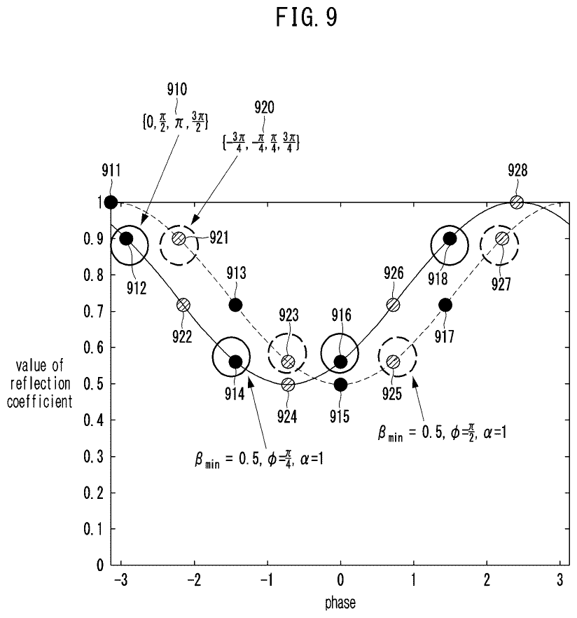

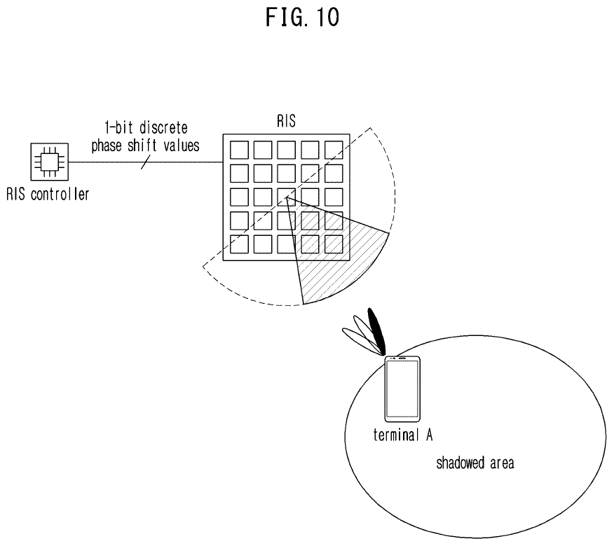

FIG. 10 is a conceptual diagram illustrating exemplary embodiments of codebook-based RIS reflection beams with 1-bit discrete phase shift values. FIG. 11 is a conceptual diagram illustrating exemplary embodiments of codebook-based RIS reflection beams with 2-bit discrete phase shift values.

Referring to FIG. 10 and FIG. 11, a 2-bit phase shift RIS reflection beam may have a more precise beam direction and a longer reach compared to a 1-bit phase shift RIS reflection beam. A terminal A is in a position favorable for receiving the RIS reflection beam, so the optimal beam can be applied among the RIS reflection beam modes composed of 1-bit phase shift values. However, a terminal B may be difficult to reach with a 1-bit RIS reflection beam. The RIS may increase the number of bits to improve communication quality for terminals that may be at distances difficult to reach with a 1-bit RIS reflection beam. Alternatively, the RIS may increase the number of bits to improve communication quality in communication environments that require slim beams.

However, to cover the area that can be covered by k 1-bit RIS reflection beams using 2-bit RIS reflection beams, the codebook may be designed to have more than k reflection beams. If the number of 2-bit RIS reflection beams to service the same area is k′, a time required for beam searching to configure the optimal beam set may increase by m×k′. Here, k and k′ may be positive integers, and k′ may be greater than k.

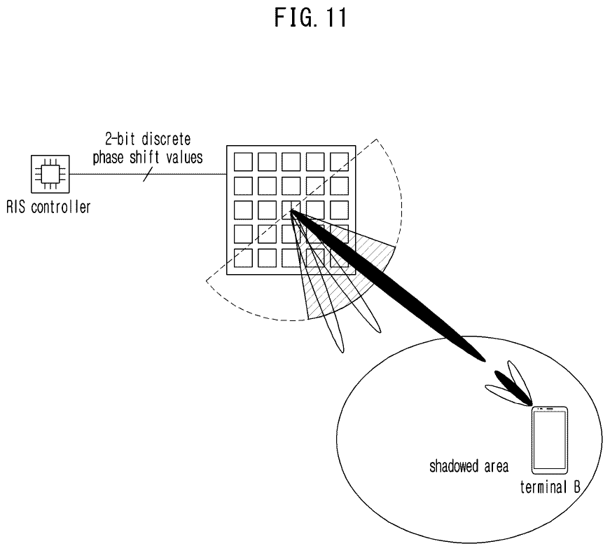

FIG. 12 is a conceptual diagram illustrating exemplary embodiments of a codebook based on multiple reflection elements.

Referring to FIG. 12, the base station may generate a codebook with 1-bit discrete phase shift values by quantizing continuous phase shift values for multiple reflection elements, as shown in (a) of FIG. 12. Here, the codebook may be represented as {0,0,0,1} for four reflection elements. In this case, the base station may represent a phase shift value of 0 radians as 0 and a phase shift value of π radians as 1. The RIS may have a total of four reflection elements arranged in a 2×2 grid. According to a rule of quantizing the continuous phase shift value of each reflection element into a discrete phase shift value, the phase shift values of the reflection elements may be as shown in (b) of FIG. 12 on the right. In other words, the phase shift values for the four reflection elements may be represented as {0,0,0, π}.

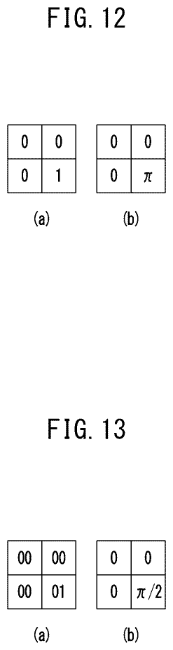

FIG. 13 is a conceptual diagram illustrating exemplary embodiments of a codebook based on a plurality of reflection elements.

Referring to FIG. 13, a base station may quantize continuous phase shift values into 2-bit discrete phase shift values for a plurality of reflection elements, as shown in (a) of FIG. 13, to generate a codebook. Here, the codebook may be expressed as {00,00,00,01} for four reflection elements. In this case, the base station may represent a phase shift value of 0 radians as 00, a phase shift value of π/2 radians as 01, a phase shift value of π radians as 10, and a phase shift value of 3π/2 radians as 11.

The RIS may have a total of four reflection elements arranged in a 2×2 grid, with two rows and two columns. When expressing continuous phase shift values of the respective reflection elements as discrete phase shift values according to a quantization rule, the phase shift values of the reflection elements may be as shown in (b) of FIG. 13 on the right. In other words, the phase shift values for the four reflection elements may be expressed as {0,0,0, π/2}.

Referring to FIGS. 12 and 13, a 1-bit phase shift value may have {0, π}, and a 2-bit phase shift value may be quantized to have {0, π/2, π, 3π/2}. When a 1-bit discrete phase shift codebook, in which four reflection elements are expressed as {0,0,0,1}, is expressed as 2-bit discrete phase shift values, it may be represented as {00, 00, 00, 01}. Observing a signal combined after phase shifts through the four reflection elements, a higher quantization level may allow finer adjustment of the phase shifts of the signal.

In the present disclosure, the base station may configure a 1-bit discrete phase shift codebook that indicates a reflection beam for each transmission beam. In this case, the number of transmission beams may be M, and the number of reflection beams for one transmission beam may be k. Here, M and k may be positive integers. Accordingly, the base station may configure M×k 1-bit discrete phase shift codebooks as shown in Equation 1.

Additionally, in the present disclosure, the base station may configure a 2-bit discrete phase shift codebook that indicates a reflection beam for each transmission beam. In this case, the number of transmission beams may be M, and the number of reflection beams for one transmission beam may be k′. Here, M and k′ may be positive integers. Accordingly, the base station may configure M×k′ 2-bit discrete phase shift codebooks as shown in Equation 6.

$${θ}_{m , {k}^{′}} = {[ \begin{matrix}{w}_{1 , 1} & {w}_{1 , 2} & … & {w}_{1 , {k}^{′}} \\ ⋮ & ⋮ & ⋱ & ⋮ \\ {w}_{m , 1} & {w}_{m , 2} & … & {w}_{m , {k}^{′}}\end{matrix} ]}^{T} \qquad [ Equation 6 ]$$

The RIS may form k reflection beams by reflecting one transmission beam according to 1-bit discrete phase shift codebooks related to the transmission beam. In this case, a reflection area toward which each reflection beam is directed may be referred to as a wide reflection area. The number of wide reflection areas may be k.

The RIS may form k′ reflection beams by reflecting one transmission beam according to 2-bit discrete phase shift codebooks related to the transmission beam. In this case, a reflection area toward which each reflection beam is directed may be referred to as a narrow reflection area. The number of narrow reflection areas may be k′. If k′ is greater than k, a wide reflection area may include multiple narrow reflection areas.

Accordingly, multiple 2-bit discrete phase shift codebooks forming narrow reflection areas included in a wide reflection area may be mapped to one 1-bit discrete phase shift codebook forming the wide reflection area. The multiple 2-bit discrete phase shift codebooks mapped to one 1-bit discrete phase variation codebook may be referred to as sub-2-bit discrete phase shift codebooks of the 1-bit discrete phase shift codebook. Alternatively, the multiple 2-bit discrete phase shift codebooks mapped to one 1-bit discrete phase shift codebook may be referred to as sub-codebooks or a sub-codebook set of the 1-bit discrete phase shift codebook. A 1-bit discrete phase shift codebook may be related to a transmission beam and a reflection beam. Additionally, a 2-bit discrete phase shift codebook may be related to a transmission beam and a reflection beam.

At least one reflection beam forming a narrow reflection areas included in a wide reflection area may be mapped to one reflection beam forming the wide reflection area. Reflection beams corresponding to multiple 2-bit discrete phase shift codebooks mapped to a reflection beam generated by one 1-bit discrete phase shift codebook may be sub-reflection beams of the reflection beam generated by the 2-bit discrete phase shift sub-codebooks of the 1-bit discrete phase shift codebook. Alternatively, reflection beams corresponding to multiple 2-bit discrete phase shift codebooks mapped to a reflection beam generated by one 1-bit discrete phase shift codebook may be sub-reflection beams or a sub-reflection beam set of the reflection beam generated by the 2-bit discrete phase shift sub-codebooks of the 1-bit discrete phase shift codebook.

Accordingly, in the present disclosure, the base station may configure multiple 2-bit discrete phase shift-based sub-codebooks for each 1-bit discrete phase shift codebook. The base station may form multiple reflection beams using the configured 2-bit discrete phase shift-based sub-codebooks.

For example, the base station may configure 2-bit phase shift-based codebooks at regular angle intervals to form sub-reflection beams concerning the direction and beamwidth of the reflection beam of the RIS generated by the 1-bit discrete phase shift codebook, thereby constituting a sub-reflection beam set. In another example, when the reflection beam k for the transmission beam m is an RIS reflection beam directed in a direction θₐ, the base station may adjust the phase shift values of the reflection elements to introduce a phase shift of +Δθ in the optimal beam pattern having continuous phase shift values that define the reflection beam direction and beamwidth. The continuous phase shift values may then be quantized into 2 bits to configure a 2-bit phase shift-based codebook.

FIG. 14 is a sequence chart illustrating exemplary embodiments of beam configuration by applying a 1-bit phase shift codebook.

Referring to FIG. 14, a base station may select one transmission beam m from among transmission beams (S1401). The base station may select one 1-bit phase shift codebook from among k 1-bit phase shift codebooks corresponding to the transmission beam m (S1402). Alternatively, the base station may select an index of one 1-bit phase shift codebook from among k 1-bit phase shift codebooks corresponding to the transmission beam m. The base station may transmit the one 1-bit phase shift codebook from among k 1-bit phase shift codebooks corresponding to the transmission beam m to an RIS controller (S1403). Alternatively, the base station may transmit an index of the one 1-bit phase shift codebook from among the indexes of k 1-bit phase shift codebooks corresponding to the transmission beam m to the RIS controller.

The RIS controller may receive the one 1-bit phase shift codebook from the base station and transmit the received 1-bit phase shift codebook to the RIS (S1404). Alternatively, the RIS controller may receive the index of one 1-bit phase shift codebook from the base station and transmit the received index to the RIS.

The RIS may receive the one 1-bit phase shift codebook from the RIS controller and store and manage the received 1-bit phase shift codebook. Alternatively, the RIS may receive the index of one 1-bit phase shift codebook from the RIS controller and store and manage the received index.

The base station may transmit one transmission beam m according to the one 1-bit phase shift codebook to the RIS (S1405). Alternatively, the base station may transmit one transmission beam m according to the index of one 1-bit phase shift codebook to the RIS. The RIS may receive the transmission beam m according to one 1-bit phase shift codebook from the base station and reflect the received transmission beam m toward the RIS to form a reflection beam (S1406). Alternatively, the RIS may receive the one transmission beam m according to the index of one 1-bit phase shift codebook from the base station and reflect the received transmission beam m toward the RIS to form a reflection beam.

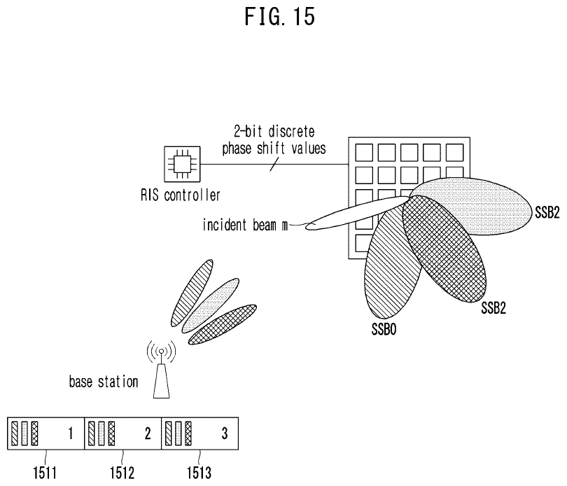

FIG. 15 is a conceptual diagram illustrating exemplary embodiments of reflection patterns according to a 1-bit phase shift codebook.

Referring to FIG. 15, the base station may periodically transmit initial synchronization signals (e.g. SSBs) with different indexes in different directions. In this case, the base station may transmit the initial synchronization signals in different directions using a beam sweeping scheme. When transmitting an initial synchronization signal set, the base station may configure a beam direction of the RIS differently. Three initial synchronization signal sets may be transmitted in different reflection directions by the RIS. The initial synchronization signal sets 1511, 1512, and 1513 may each include m initial synchronization signals. Here, m may be, for example, 3.

The initial synchronization signal may include both a beam index of the base station and a beam index of the RIS. Three different beam indexes may exist for the base station. Three different beam indexes may exist for the RIS. Therefore, 9 initial synchronization signals may exist, and the 9 initial synchronization signals may include different indexes. For example, if one initial synchronization signal (e.g. SSB0) has a beam index 1 of the base station and a beam index 0 of the RIS, another initial synchronization signal (e.g. SSB1) may have the beam index 1 of the base station and a beam index 1 of the RIS, and yet another initial synchronization signal (e.g. SSB2) may have the beam index 1 of the base station and a beam index 2 of the RIS.

Referring again to FIG. 14, the terminal may receive the reflection beam from the RIS, measure a received signal quality of the received reflection beam, and acquire channel state information (S1407). Here, a metric for measuring the received signal quality may include a metric representing the received signal strength, such as RSRP, RSRQ, SNR, and BER.

Meanwhile, the base station may select another 1-bit phase shift codebook from among k 1-bit phase shift codebooks corresponding to the one transmission beam m. Alternatively, the base station may select an index of another 1-bit phase shift codebook from among k 1-bit phase shift codebooks corresponding to the one transmission beam m. The base station may transmit another 1-bit phase shift codebook from among k 1-bit phase shift codebooks corresponding to the one transmission beam m to the RIS controller. Alternatively, the base station may transmit an index of another 1-bit phase shift codebook from among the indexes of k 1-bit phase shift codebooks corresponding to the one transmission beam m to the RIS controller.

The RIS controller may receive the one 1-bit phase shift codebook from the base station and transmit the received 1-bit phase shift codebook to the RIS. Alternatively, the RIS controller may receive the index of one 1-bit phase shift codebook from the base station and transmit the received index to the RIS.

The RIS may receive the one 1-bit phase shift codebook from the RIS controller and store and manage the received 1-bit phase shift codebook. Alternatively, the RIS may receive the index of one 1-bit phase shift codebook from the RIS controller and store and manage the received index.

The base station may transmit the one transmission beam m according to the one 1-bit phase shift codebook to the RIS. Alternatively, the base station may transmit the one transmission beam m according to the index of one 1-bit phase shift codebook to the RIS. The RIS may receive the transmission beam m according to the one 1-bit phase shift codebook from the base station and reflect the received transmission beam m toward the RIS to form a reflection beam. Alternatively, the RIS may receive the one transmission beam m according to the index of one 1-bit phase shift codebook from the base station and reflect the received transmission beam m toward the RIS to form a reflection beam.

The terminal may receive the reflection beam from the RIS, measure a received signal quality of the received reflection beam, and acquire channel state information. Here, a metric for measuring the received signal quality may include a metric representing the received signal strength, such as RSRP, RSRQ, SNR, and BER.

The base station may perform all the processes of steps S1402 to S1407 for k 1-bit phase shift codebooks corresponding to the one transmission beam m. Additionally, the base station may select another transmission beam from among the transmission beams and perform all the processes of steps S1402 to S1407. The base station may perform such processes for all M transmission beams.

The terminal may report to the base station information on the transmission beam and reflection beam with the best received signal quality from among the received signal qualities measured for the k reflection beams corresponding to each of the M transmission beams (S1408). The terminal may also report channel state information to the base station. The base station may receive from the terminal the information on the transmission beam and reflection beam with the best received signal quality, along with the channel state information. The base station may provide communication services to the terminal using the received information on the transmission beam and reflection beam with the best received signal quality and the channel state information.

In this case, the terminal may measure the received signal quality for all the transmission beams and then provide feedback of the measurement results to the base station. In such cases, the terminal may experience significant delay before initiating communication, so the terminal may set a threshold for the received signal strength and provide feedback only for reflection beams with received signal strength equal to or greater than the threshold. The terminal may transmit multiple feedback signals to the base station through physical random access channel(s) (PRACH(s)), physical uplink control channel(s) (PUCCH(s)), or other channels.

The base station may collect feedback information transmitted from the terminal and determine a final beam set. When the base station determines that it is necessary to improve a reception sensitivity of the terminal based on the terminal's channel state information, the base station may select a sub-group of RIS reflection beams based on 2-bit phase shifts for the optimal pair of <incident beam, RIS reflection beam>, based on the optimal beam set. The base station may then deliver codebook index information for the 2-bit phase shift-based beam group to the RIS controller. Such a process may be included in an initial access phase, where the optimal beam is selected by measuring the received signal strength for each beam during SSB transmission. Alternatively, during a data transmission phase after initial access, signal quality of the sub-beam group may be measured in an RS signal transmission period for fine beam adjustment. Here, the RS signal may be designed to measure channel state information, similar to the reference signals (RS) defined by 3GPP, using pilot transmission.

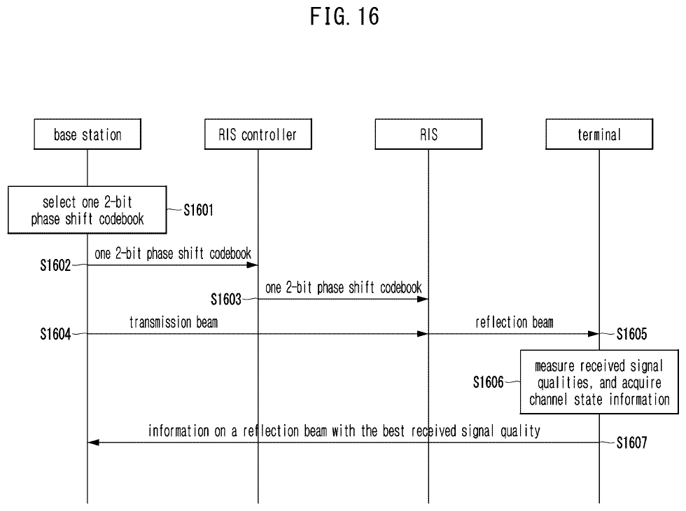

FIG. 16 is a sequence chart illustrating exemplary embodiments of beam configuration by applying a 2-bit phase shift codebook.

Referring to FIG. 16, the base station may configure at least one 2-bit discrete phase shift codebook for the 1-bit discrete phase shift codebook determined based on the information on the transmission beam and reflection beam with the best received signal quality received from the terminal through the process described in FIG. 14. Here, the at least one 2-bit discrete phase shift codebook may be sub-codebooks or a sub-codebook set of the corresponding 1-bit discrete phase shift codebook.

The base station may select one 2-bit phase shift codebook from among at least one 2-bit phase shift codebook corresponding to the 1-bit phase shift codebook determined through the process of FIG. 14 (S1601). Alternatively, the base station may select an index of one 2-bit phase shift codebook from among at least one 2-bit phase shift codebook corresponding to the 1-bit phase shift codebook determined through the process of FIG. 14. The base station may transmit the one 2-bit phase shift codebook to the RIS controller (S1602). Alternatively, the base station may transmit the index of one 2-bit phase shift codebook to the RIS controller.

The RIS controller may receive the one 2-bit phase shift codebook from the base station and transmit the received 2-bit phase shift codebook to the RIS (S1603). Alternatively, the RIS controller may receive the index of one 2-bit phase shift codebook from the base station and transmit the received index to the RIS.

The RIS may receive the one 2-bit phase shift codebook from the RIS controller and store and manage the received 2-bit phase shift codebook. Alternatively, the RIS may receive the index of one 2-bit phase shift codebook from the RIS controller and store and manage the received index of the 2-bit phase shift codebook.

The base station may transmit the transmission beam determined through the process described in FIG. 14 to the RIS (S1604). The RIS may receive the transmission beam from the base station and reflect the received transmission beam toward the RIS to form, for example, three reflection beams (S1605). Alternatively, the RIS may receive the transmission beam from the base station and reflect the received transmission beam toward the RIS to form, for example, three reflection beams.

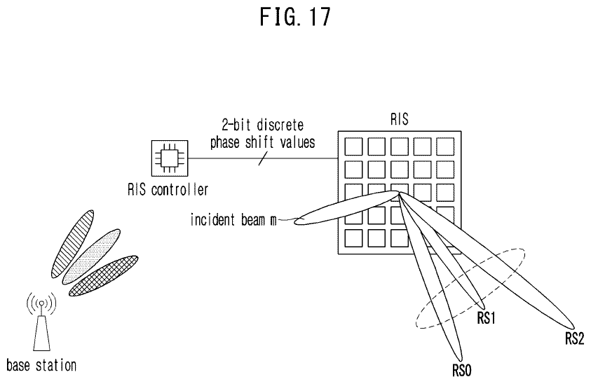

FIG. 17 is a conceptual diagram illustrating exemplary embodiments of reflection patterns according to a 2-bit phase shift codebook.

Referring to FIG. 17, the base station may periodically transmit reference signals (e.g. RSs) with different indexes in different directions. In this case, the base station may transmit the reference signals in different directions using a beam sweeping scheme. When transmitting a reference signal set, the base station may configure a beam direction of the RIS differently. Three reference signal sets may be transmitted in different reflection directions by the RIS. The reference signal may include both a beam index of the base station and a beam index of the RIS. Three different beam indexes may exist for the base station. Three different beam indexes may exist for the RIS. Therefore, 9 reference signals may exist, and the 9 reference signals may include different indexes. For example, if one reference signal (e.g. RS0) has a beam index 1 of the base station and a beam index 0 of the RIS, another reference signal (e.g. RS1) may have the beam index 1 of the base station and a beam index 1 of the RIS, and yet another reference signal (e.g. RS2) may have the beam index 1 of the base station and a beam index 2 of the RIS.

Referring again to FIG. 16, the terminal may receive the reflection beam from the RIS, measure a received signal quality of the received reflection beam, and acquire channel state information (S1606). Here, a metric for measuring the received signal quality may include a metric representing the received signal strength, such as RSRP, RSRQ, SNR, and BER.

Meanwhile, the base station may select another 2-bit phase shift codebook from at least one 2-bit phase shift codebook corresponding to the transmission beam and the 1-bit phase shift codebook determined in FIG. 14. Alternatively, the base station may select an index of another 2-bit phase shift codebook. The base station may transmit the another 2-bit phase shift codebook to the RIS controller. Alternatively, the base station may transmit the index of another 2-bit phase shift codebook to the RIS controller.

The RIS controller may receive the another 2-bit phase shift codebook from the base station and transmit the received 2-bit phase shift codebook to the RIS. Alternatively, the RIS controller may receive the index of another 2-bit phase shift codebook from the base station and transmit the received index to the RIS.

The RIS may receive the another 2-bit phase shift codebook from the RIS controller and store and manage the received 2-bit phase shift codebook. Alternatively, the RIS may receive the index of another 2-bit phase shift codebook from the RIS controller and store and manage the received index.

The base station may transmit a transmission beam according to the another 2-bit phase shift codebook to the RIS. Alternatively, the base station may transmit a transmission beam according to the index of another 2-bit phase shift codebook to the RIS. The RIS may receive the transmission beam from the base station according to the another 2-bit phase shift codebook and reflect the received transmission beam toward the RIS to form, for example, three reflection beams. Alternatively, the RIS may receive the transmission beam from the base station according to the index of another 2-bit phase shift codebook and reflect the received transmission beam toward the RIS to form, for example, three reflection beams.

The terminal may receive the reflection beams from the RIS, measure the received signal quality for each of the received reflection beams, and acquire channel state information. Here, a metric for measuring the received signal quality may include a metric representing the received signal strength, such as RSRP, RSRQ, SNR, and BER.

The base station may perform all the processes of steps S1602 to S1606 for the transmission beam determined in FIG. 14 and the 2-bit phase shift codebooks subordinate to the 1-bit discrete phase shift codebook.

The terminal may report to the base station a reflection beam with the best received signal quality from among the received signal qualities measured for the reflection beams of the transmission beam (S1607). The terminal may also report channel state information to the base station. The base station may receive from the terminal the information on the transmission beam and reflection beam with the best received signal quality, along with the channel state information. The base station may provide communication services to the terminal using the received information on the transmission beam and reflection beam with the best received signal quality and the channel state information.

### Another Reflection Beam Selection Method Using 2-Bit Discrete Phase Shift Codebook

The base station may collect feedback information transmitted from the terminal and determine a final beam set. When the base station determines that it is necessary to improve a reception sensitivity of the terminal based on the terminal's channel state information, the base station may select a group of RIS reflection beams based on 2-bit phase shifts for the optimal pair of <incident beam, RIS reflection beam>, based on the optimal beam set. The base station may deliver codebook index information for the 2-bit phase shift-based beam group to the RIS controller. Such a process may be included in the initial access phase, where the optimal beam is selected by measuring the received signal strength for each beam during SSB transmission. Alternatively, during the data transmission phase after initial access, the signal quality of the beam group may be measured in the RS signal transmission interval for fine beam adjustment.

The base station may select one 2-bit phase shift codebook from the 2-bit phase shift codebooks related to the transmission beam with the best received signal quality, received from the terminal through the process described in FIG. 14. Alternatively, the base station may select an index of one 2-bit phase shift codebook from the 2-bit phase shift codebooks related to the transmission beam determined through the process of FIG. 14. The base station may transmit one 2-bit phase shift codebook to the RIS controller. Alternatively, the base station may transmit an index of one 2-bit phase shift codebook to the RIS controller.

The RIS controller may receive the one 2-bit phase shift codebook from the base station and transmit the received 2-bit phase shift codebook to the RIS. Alternatively, the RIS controller may receive the index of one 2-bit phase shift codebook from the base station and transmit the received index of the 2-bit phase shift codebook to the RIS.

The RIS may receive the one 2-bit phase shift codebook from the RIS controller and store and manage the received 2-bit phase shift codebook. Alternatively, the RIS may receive the index of one 2-bit phase shift codebook from the RIS controller and store and manage the received index of the 2-bit phase shift codebook.

The base station may transmit the transmission beam determined through the process described in FIG. 14 to the RIS. The RIS may receive the transmission beam from the base station and reflect the received transmission beam toward the RIS to form, for example, three reflection beams. Alternatively, the RIS may receive the transmission beam from the base station and reflect the received transmission beam toward the RIS to form, for example, three reflection beams.

The terminal may receive the reflection beams from the RIS, measure the received signal quality of each of the received reflection beams, and acquire channel state information. Here, indicators for measuring the received signal quality may include indicators representing the received signal strength, such as RSRP, RSRQ, SNR, and BER. The base station may select another 2-bit phase shift codebook from the 2-bit phase shift codebooks related to the transmission beam determined in FIG. 14. Alternatively, the base station may select an index of another 2-bit phase shift codebook. The base station may transmit another 2-bit phase shift codebook to the RIS controller. Alternatively, the base station may transmit an index of another 2-bit phase shift codebook to the RIS controller.

The RIS controller may receive another 2-bit phase shift codebook from the base station and transmit the received 2-bit phase shift codebook to the RIS. Alternatively, the RIS controller may receive an index of another 2-bit phase shift codebook from the base station and transmit the received index of the 2-bit phase shift codebook to the RIS.

The RIS may receive the another 2-bit phase shift codebook from the RIS controller and store and manage the received 2-bit phase shift codebook. Alternatively, the RIS may receive the index of another 2-bit phase shift codebook from the RIS controller and store and manage the received index of the 2-bit phase shift codebook.

The base station may transmit a transmission beam to the RIS according to another 2-bit phase shift codebook. Alternatively, the base station may transmit a transmission beam to the RIS according to the index of another 2-bit phase shift codebook. The RIS may receive the transmission beam from the base station according to another 2-bit phase shift codebook and reflect the received transmission beam toward the RIS to form, for example, three reflection beams. Alternatively, the RIS may receive the transmission beam from the base station according to the index of another 2-bit phase shift codebook and reflect the received transmission beam toward the RIS to form, for example, three reflection beams.

The terminal may receive the reflection beams from the RIS, measure the received signal quality of each of the received reflection beams, and acquire channel state information. Here, a metric for measuring the received signal quality may include a metric representing the received signal strength, such as RSRP, RSRQ, SNR, and BER.

The base station may perform all the processes of steps S1602 to S1606 for the 2-bit phase shift codebooks related to the transmission beam determined in FIG. 14.

The terminal may report to the base station the reflection beam with the best received signal quality from among the received signal qualities measured for the reflection beams of the transmission beam. The terminal may also report channel state information to the base station. The base station may receive from the terminal the information on the transmission beam and reflection beam with the best received signal quality, along with the channel state information. The base station may provide communication services to the terminal using the received information on the transmission beam and reflection beam with the best received signal quality and the channel state information.

In the present disclosure, the RIS controller may perform the role of programming the reflection coefficients of the RIS to configure the RIS reflection beams according to the codebook index transmitted from the base station. Additionally, the RIS controller may configure the reflection beam mode based on the codebook index transmitted from the base station without requiring information on the incident beam, and the beam management for the RIS may occur at the base station. However, in the present disclosure, the functions of the base station, terminal, and RIS are not limited to the proposed functions, and the functions of the base station may also be included in the terminal, while the beam management function of the base station may be performed by the RIS controller.

According to the configuration of the present disclosure, the base station can design the codebook without significantly increasing the complexity of codebook-based RIS reflection beam design. Additionally, according to the present disclosure, the base station can improve the performance of RIS reflection beamforming accuracy and coverage distance. Accordingly, the RIS can cover wider shadowed areas and enhance communication performance for each user. Furthermore, by collecting information on the RIS reflection areas in advance, communication interruptions can be quickly addressed. Through this, performance improvements in networks utilizing intelligent reflective surfaces can be expected.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In exemplary embodiments, a programmable logic device (e.g. field-programmable gate array) may be used to perform some or all of the functions of the methods described herein. In exemplary embodiments, the field-programmable gate array (FPGA) may operate in conjunction with a microprocessor to perform one of the methods described herein. Generally, it is preferable for the methods to be performed by some hardware device.

While the present disclosure has been described with reference to preferred exemplary embodiments, those skilled in the art will understand that various modifications and changes can be made to the present disclosure without departing from the spirit and scope of the present disclosure as set forth in the following claims.

What is claimed is:

1. A method of a base station, comprising:
generating first installation information of the base station including information on at least one transmission beam;
requesting second installation information of a reconfigurable intelligent surface (RIS) from an RIS controller, the RIS being located nearby the base station;
receiving, from the RIS controller, the second installation information including information on at least one reflection beam of the RIS; and
determining at least one shadowed area covered by the at least one transmission beam and the at least one reflection beam based on the first installation information and the second installation information.

2. The method according to claim 1, wherein the information on the at least one transmission beam includes at least one of: information on a number of the at least one transmission beam, information on a beam width of each of the at least one transmission beam, or information on a beam direction of each of the at least one transmission beam.

3. The method according to claim 1, wherein the information on the at least one reflection beam includes at least one of: information on a number of reflection beams for the at least one transmission beam, information on a beam width of each of the reflection beams for the at least one transmission beam, or information on a beam direction of each of the reflection beams for the at least one transmission beam.

4. The method according to claim 1, wherein the first installation information includes one of information on an installation location of the base station or information on a number of the at least one transmission beam of the base station.

5. The method according to claim 1, wherein the second installation information includes at least one of: information on an installation location of the RIS, information on a number of reflection elements of the RIS, or information on an azimuth of the RIS.

6. The method according to claim 1, further comprising: generating a mapping table by mapping an identifier (ID) of the RIS, information on one transmission beam from the at least one transmission beam, information on one reflection beam from the at least one reflection beam, and information on one shadowed area from the at least one shadowed area.

7. The method according to claim 1, further comprising:
providing a service to a terminal;
estimating a location of the terminal;
identifying an interruption of the service for the terminal;
identifying that the terminal exists in one shadowed area among the at least one shadowed area;
selecting one transmission beam of the at least one transmission beam and one reflection beam of the at least one reflection beam, which cover the one shadowed area; and
transmitting a signal to the terminal via the RIS based on the selected one transmission beam and the selected one reflection beam.

8. The method according to claim 7, wherein the transmitting of the signal to the terminal via the RIS based on the selected one transmission beam and the selected one reflection beam comprises:
identifying a codebook based on the selected one transmission beam and the selected one reflection beam;
transmitting the identified codebook to the RIS controller; and
transmitting the signal to the RIS using the selected one transmission beam.

9. The method according to claim 7, wherein the selecting of the one transmission beam of the at least one transmission beam and the one reflection beam of the at least one reflection beam, which cover the one shadowed area, comprises:
transmitting, to the RIS controller, 1-bit discrete phase shift codebooks related to the selected one transmission beam;
transmitting, to the RIS, first reference signals related to the 1-bit discrete phase shift codebooks;
receiving, from the terminal, information on first received signal qualities for the first reference signals;
identifying one first reference signal of the first reference signals, which has a best received signal quality, based on the first received signal qualities;
identifying one 1-bit discrete phase shift codebook corresponding to the identified one first reference signal; and
selecting a reflection beam related to the identified one 1-bit discrete phase codebook as the selected one reflection beam.

10. The method according to claim 9, wherein the selecting of the reflection beam related to the identified one 1-bit discrete phase codebook as the selected one reflection beam comprises:
transmitting, to the RIS controller, 2-bit discrete phase codebooks subordinate to the identified one 1-bit discrete phase shift codebook;
transmitting, to the RIS, second reference signals related to the 2-bit discrete phase shift codebooks;
receiving, from the terminal, information on second received signal qualities for the second reference signals;
identifying one second reference signal of the second reference signals, which has a best received signal quality, based on the second received signal qualities;
identifying one 2-bit discrete phase shift codebook corresponding to the one second reference signal; and
selecting a reflection beam formed by the identified one 2-bit discrete phase codebook as the selected one reflection beam,
wherein a reflection area of the reflection beam formed by the identified one 2-bit discrete phase codebook is included in a reflection area of the selected one reflection beam formed by the identified one 1-bit discrete phase codebook.

11. A method of a reconfigurable intelligent surface (RIS) controller, comprising:
receiving, from a base station, a request for first installation information of an RIS;
transmitting, to the base station, the first installation information including information on at least one reflection beam of the RIS;
receiving, from the base station, a codebook related to at least one transmission beam and at least one reflection beam determined based on the first installation information and second installation information of the base station; and
transmitting, to the RIS, the codebook received from the base station.

12. The method according to claim 11, wherein the first installation information includes one of information on an installation location of the RIS or information on a number of reflection elements of the RIS.

13. The method according to claim 11, wherein the second installation information includes one of information on an installation location of the base station or information on a number of the at least one transmission beam of the base station.

14. The method according to claim 11, wherein the codebook is a 1-bit discrete phase shift codebook or a 2-bit discrete phase codebook.

15. A base station comprising at least one processor, wherein the at least one processor causes the base station to perform:
generating first installation information of the base station including information on at least one transmission beam;
requesting second installation information of a reconfigurable intelligent surface (RIS) from an RIS controller, the RIS being located nearby the base station;
receiving, from the RIS controller, the second installation information including information on at least one reflection beam of the RIS; and
determining at least one shadowed area covered by the at least one transmission beam and the at least one reflection beam based on the first installation information and the second installation information.

16. The base station according to claim 15, wherein the at least one processor further causes the base station to perform:
providing a service to a terminal;
estimating a location of the terminal;
identifying an interruption of the service for the terminal;
identifying that the terminal exists in one shadowed area among the at least one shadowed area;
selecting one transmission beam of the at least one transmission beam and one reflection beam of the at least one reflection beam, which cover the one shadowed area; and
transmitting a signal to the terminal via the RIS based on the selected one transmission beam and the selected one reflection beam.

17. The base station according to claim 16, wherein in the transmitting of the signal to the terminal via the RIS based on the selected one transmission beam and the selected one reflection beam, the at least one processor further causes the base station to perform:
identifying a codebook based on the selected one transmission beam and the selected one reflection beam;
transmitting the identified codebook to the RIS controller; and
transmitting the signal to the RIS using the selected one transmission beam.

18. The base station according to claim 16, wherein in the selecting of the one transmission beam of the at least one transmission beam and the one reflection beam of the at least one reflection beam, which cover the one shadowed area, the at least one processor further causes the base station to perform:
transmitting, to the RIS controller, 1-bit discrete phase shift codebooks related to the selected one transmission beam;
transmitting, to the RIS, first reference signals related to the 1-bit discrete phase shift codebooks;
receiving, from the terminal, information on first received signal qualities for the first reference signals;
identifying one first reference signal of the first reference signals, which has a best received signal quality, based on the first received signal qualities;
identifying one 1-bit discrete phase shift codebook corresponding to the identified one first reference signal; and
selecting a reflection beam related to the identified one 1-bit discrete phase codebook as the selected one reflection beam.
